(19) United States
(12) Patent Application Publication
(10) Pub. No.: US 2023/0149750 A1
(43) Pub. Date: May 18, 2023

(54) Face Masks and Methods of Producing Same

(71) Applicant: ThermoPore Materials Corporation, Newnan, GA (US)

(72) Inventor: Ken Milam, Newnan, GA (US)

(21) Appl. No.: 17/920,691

(22) PCT Filed: Jun. 7, 2021
(86) PCT No.: PCT/US2021/036116

§ 371 Date: Oct. 21, 2022

Related U.S. Application Data
(60) Provisional application No. 63/036,141, filed on Jun. 8, 2020.

(51) Int. Cl. A62B 23/02; A62B 18/08; A62B 18/10; A41D 13/11; B01D 39/16

(52) U.S. Cl. CPC A62B 23/025; A62B 18/084; A62B 18/10; A41D 13/1146; B01D 39/16; B01D 2239/1291

(57) ABSTRACT

A face mask includes a filter body including a composite film. The composite film includes a first layer of a stretched sintered polymeric material, and a second layer of an expanded polymer film secured to the first layer. The face mask includes one or more straps for securing the filter body over the mouth and nose of a wearer. A process for making a face mask includes providing a composite film including a sintered polymeric material adjacent an expanded polymer film, thermoforming the composite film to produce a filter body of the face mask, and attaching one or more straps to the filter body.

### CROSS-REFERENCE TO RELATED APPLICATIONS

This application claims priority to U.S. Provisional Application No. 63/036,141, filed Jun. 8, 2020, which is incorporated by reference herein in its entirety.

### BACKGROUND

### Technical Field

The disclosure is generally in the field of face masks and methods of producing face masks.

### Description of Related Art

Face masks are used to reduce or avoid exposure to contaminants and pathogens. Face masks may include a substrate that inhibits or blocks passage of particles, liquids, and microorganisms, while permitting passage of air for breathing. Face masks may be provided in a shape, for example, a two-dimensional shape, or a three-dimensional contour, for facilitating wearing, retention, and comfort.

A need remains for improved face masks and techniques of making face masks.

### SUMMARY

Improved face masks and techniques of making face masks are provided. In one aspect, the face mask includes a filter body including a composite film, wherein the composite film includes a first layer of a sintered polymeric material, and a second layer of an expanded polymer film secured to the first layer. In preferred embodiments, the filter body is shaped and dimensioned to cover the mouth and nose of a person. The face mask may include one or more straps for securing the filter body over the mouth and nose of a wearer.

In another aspect, a process is provided for making a face mask, wherein the process includes (i) providing a composite film including a sintered polymeric material adjacent an expanded polymer film, (ii) thermoforming the composite film to produce a filter body of the face mask, and optionally (iii) attaching one or more straps to the filter body.

### BRIEF DESCRIPTION OF THE DRAWINGS

Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1A is a conceptual diagram showing a front, perspective view of a face mask including a filter body that includes a composite film.

FIG. 1B is a conceptual diagram showing a partial cross-sectional, perspective view of the face mask of FIG. 1A.

FIG. 1C is a conceptual diagram showing a cross-sectional view of the composite film of the face mask of FIG. 1A.

FIG. 2 is a conceptual diagram showing a plan view of a precursor composite film including a first layer of a precursor polymeric material adjacent a second layer of a precursor polymer film.

FIG. 3 is a conceptual diagram showing a perspective view of a two-part mold assembly for making a face mask.

FIG. 4 is a photograph showing a scanning electron microscopy (SEM) image of a precursor sintered polymeric material before thermoforming.

FIG. 5 is a photograph showing a scanning electron microscopy (SEM) image of a sintered polymeric material of FIG. 4 after thermoforming.

FIG. 6 is a photograph showing a scanning electron microscopy (SEM) image of a precursor expanded polymeric film (PTFE) before thermoforming.

FIG. 7 is a photograph showing a scanning electron microscopy (SEM) image of the polymeric film of FIG. 6 after thermoforming.

It is to be understood that the invention is not limited in its application to the details of construction and the arrangement of components illustrated in the drawings or set forth in the following description.

### DETAILED DESCRIPTION

Improved face masks and techniques of making face masks have been developed. In embodiments, a face mask includes a filter body including a composite film. The composite film includes a first layer of a sintered polymeric material, and a second layer of an expanded polymer film secured to the first layer. In a preferred embodiment, the sintered polymeric layer is a stretched sintered polymeric layer and the expanded polymer film is a stretched expanded polymer film. The “stretched” characteristic of these layers and films results at least in part from plastic deformation of these materials, e.g., by a thermoforming process. The face mask may include one or more straps, e.g., a pair of straps, for securing the filter body over the mouth and nose of a wearer.

Masks according to the present disclosure may have one or more of the following advantages: easily formable into a variety of shapes, can be sterilized and reused, offers an enhanced seal compared to conventional masks, offers enhanced barrier properties, offers enhanced air flow, offers more rigidity for ease of repositioning, embodies a soft and non-agitating inner surface, and is made from readily available polymeric materials.

In embodiments, a process for making a face mask includes providing a composite film including a sintered polymeric material adjacent an expanded polymer film, thermoforming the composite film to produce a filter body of the face mask, and optionally attaching one or more straps to the filter body. In other embodiments, the filter body may be secured within a pouch of another holder/means known in the art for securing a filter body about a person's mouth and nose.

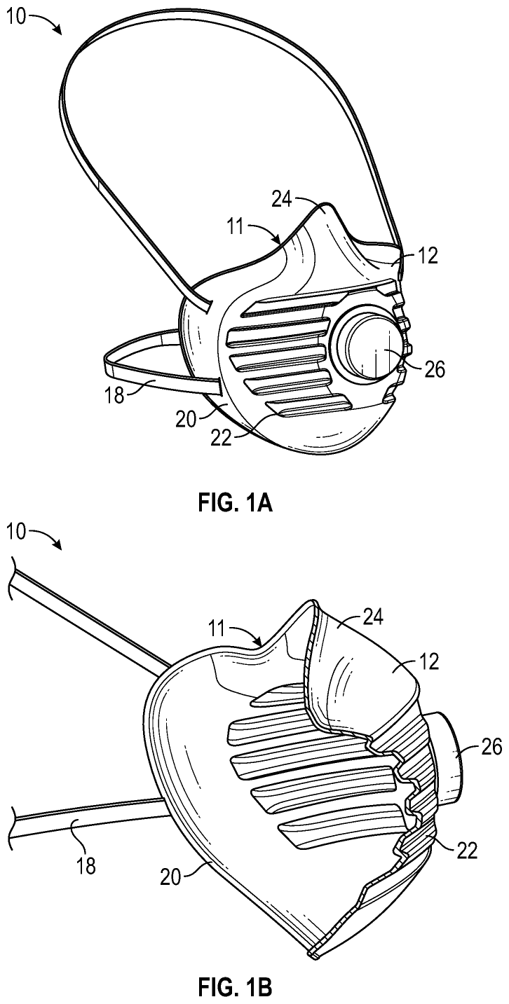

FIG. 1A is a conceptual diagram showing a front, perspective view of a face mask 10 including a filter body 11 that includes a composite film 12. FIG. 1B is a conceptual diagram showing a partial cross-sectional, perspective view of face mask 10 of FIG. 1A. FIG. 1C is a conceptual diagram showing a cross-sectional view of part of the composite film 12 of face mask 10 of FIG. 1A. In embodiments, composite film 12 includes a first layer 14 of a sintered polymeric material, and a second layer 16 of an expanded polymer film secured to first layer 14. In a preferred embodiment, first layer 14 includes a stretched sintered polymeric layer. In a preferred embodiment, second layer 16 includes a stretched expanded polymer film.

Composite film 12 acts as a barrier for pathogens, liquids, or generally for contaminants, while allowing passage of air. For example, one or both of first layer 14 and second layer 16 may reduce or prevent passage of liquids and contaminants, and both first layer 14 and second layer 16 may substantially permit passage of air.

In embodiments, the sintered polymeric material of first layer 14 is laminated to the expanded polymer film of second layer 16. The layers may be laminated in the course of molding or thermoforming face mask 10, or otherwise by thermal processing prior to thermoforming. In embodiments, face mask 10 may include an adhesive layer between first layer 14 and second layer 16.

The sintered polymeric material in first layer 14 may include a beaded or particulate material that is thermoformed, or otherwise heat-treated to promote elongation of the beads or particles of the sintered polymeric material. In some embodiments, the sintered polymeric material includes polyethylene. In some preferred embodiments, the sintered polymeric material includes low melt flow polymers such as high density or ultra high molecular weight polyethylene or fractional melt polypropylene. In at least some preferred embodiments, the polymeric material is a low melt flow polymer so that during heat processing, including thermoforming, the sintered porous structure remains suitably intact and porous. In a preferred embodiment, first layer 14 is free of conventional fibrous or fiber-based materials such as melt-blown and/or spunbond materials. For example, first layer 14 may be free of woven fibrous material or nonwoven fibrous material. Thus, in some embodiments, no fiber or fibrous material is present in first layer 14.

The sintered polymeric material in first layer 14 may define voids or pores. The voids or pores may be at least partially interconnected to provide a passage through first layer 14. In some embodiments, the porosity of the sintered polymeric material may be in a range of 5 microns to 250 microns.

The expanded polymer film in second layer 16 may include an expanded fluoropolymer matrix, or other nanofiber materials that can undergo thermoforming without loss of function. For example, the fluoropolymer may include polytetrafluoroethylene (PTFE). In embodiments, the expanded polymer film defines a matrix including nodules and fibrils. In a preferred embodiment, second layer 16 is free of conventional fibrous or fiber-based materials such as melt-blown and/or spunbond materials. For example, second layer 16 may be free of woven fibrous material or nonwoven fibrous material. Thus, in some embodiments, no fiber or fibrous material is present in second layer 16.

While fibrous material may be absent from first layer 14 or the sintered polymeric material of first layer 14, or from second layer 16 or the expanded polymeric film of second layer 16, in some embodiments, the face mask 10 may include a separate fibrous layer. For example, face mask 10 may include one or more woven or non-woven layers distinct from first layer 14 or second layer 16. Thus, in some embodiments, the face mask 10 or filter body 11 may include layers in addition to first layer 14 and second layer 16. In other embodiments, filter body 11 consists of composite film 12. Thus, filter body 11 may only include first layer 14 and second layer 16.

First layer 14, second layer 16, and composite film 12 as a whole, may have any suitable thickness. In embodiments, first layer 14 has a thickness in a range of 0.005 inch to 0.125 inch (0.1 mm to 3.2 mm). In embodiments, second layer 16 has a thickness in a range of 0.0005 inch to 0.005 inch (0.01 mm to 0.1 mm). In embodiments, composite film 12 has a thickness in a range of 0.0055 inch to 0.130 inch (0.14 mm to 3.3 mm). In embodiments, a ratio of a thickness of first layer 14 to a thickness of second layer 16 may be in a range of 1 to 250.

In embodiments, second layer 16 defines an interior surface configured to face the wearer. Without being bound by theory, providing second layer 16 including the expanded polymeric film, for example, a fluoropolymer film, on the interior of the mask promotes forming a contaminant seal against the wearer's face. Moreover, while fluoropolymers may exhibit reduced friction, the fluoropolymer of second layer 16 may exhibit a threshold amount of friction to grip or retain position against the wearer's face or skin.

Without being bound by theory, composite film 12 exhibits a synergistic effect relative to the independent properties of first layer 14 and second layer 16. For example, in isolation, a sintered polymeric material may tend to break in response to tensile stresses. Likewise in isolation, an expanded polymer film may tend to overstretch and rupture upon elongation. However in composite film 12, the combination of first layer 14 and second layer 16 allows further stretching and forming, for example, because first layer 14 supports second layer 16. Additionally, porosity of the sintered polymeric material in first layer 14 may promote breathability through filter body 11, compared to a filter body that does not include a porous or sintered material.

The combination of first layer 14 and second layer 16 in composite film 12 may also provide some flex during inhalation or exhalation, causing the mask to elastically deform to the wearer's face to some extent. Such deformation combined with the grip of second layer 16 may promote formation of a contaminant barrier seal. Such a seal may reduce or prevent migration or entry of contaminants along a peripheral region 20 of face mask 10.

In embodiments, peripheral region 20 may be relatively densified compared to rest of filter body 11. In embodiments, peripheral region 20 may include an additional layer, for example, a reinforcing layer, or a layer that promotes sealing, retention, or contact with wearer's skin.

As shown in FIG. 1A, face mask 10 may generally have a shape that conforms to a wearer's nose and mouth. For example, filter body 11 may have a convex-concave shape and be dimensioned to fit about the wearer's mouth and noses. In embodiments, filter body 11 is shaped by a thermoforming process, as described elsewhere in the present disclosure.

In some embodiments, filter body 11 defines one or more support ribs 22. Support ribs 22 may provide some flex and promote conforming of face mask 10 to a wearer's face. Support ribs 22 may also increase the surface area of face mask 10, which may promote air passage and breathability. Support ribs 22 may also introduce non-uniform and intended thickness variations in composite film 12 that increase the mask's overall breathability.

In some embodiments, face mask 10 further includes a nose piece 24 attached to filter body 11. For example, nose piece 24 may be separately formed and secured to filter body 11, by adhesive, weld, fastener, clip, or combinations thereof. In some other embodiments, nose piece 24 may be integrally formed with filter body 11, for example, in a single molded shape.

In some embodiments, face mask 10 further includes an air-valve 26 secured to the filter body. Air-valve 26 may permit relatively rapid exhalation without permitting inhalation, thus promoting breathability during exhalation. For example, the chance of contaminant migration towards the wearer during exhalation is minimal. Because air-valve may not permit inhalation, all inhaled air would pass through first layer 14 and second layer 16, which constitute a barrier to contaminants.

In embodiments, face mask 10 includes one or more straps 18 for securing filter body 11 over the mouth and nose of a wearer. Straps 18 may include one, two, or more straps. Straps 18 may be attached to peripheral region 20 of filter body 11. For example, straps 18 may be welded to filter body 11, for example, laminated or heat-welded to peripheral region 20. In embodiments, straps 18 may be secured to filter body 11, for example, by adhesive, mechanical fasteners, clips, stitches, staples, or combinations thereof. Straps 18 may be formed of a polymeric material. In some preferred embodiments, straps 18 are elastic and resilient.

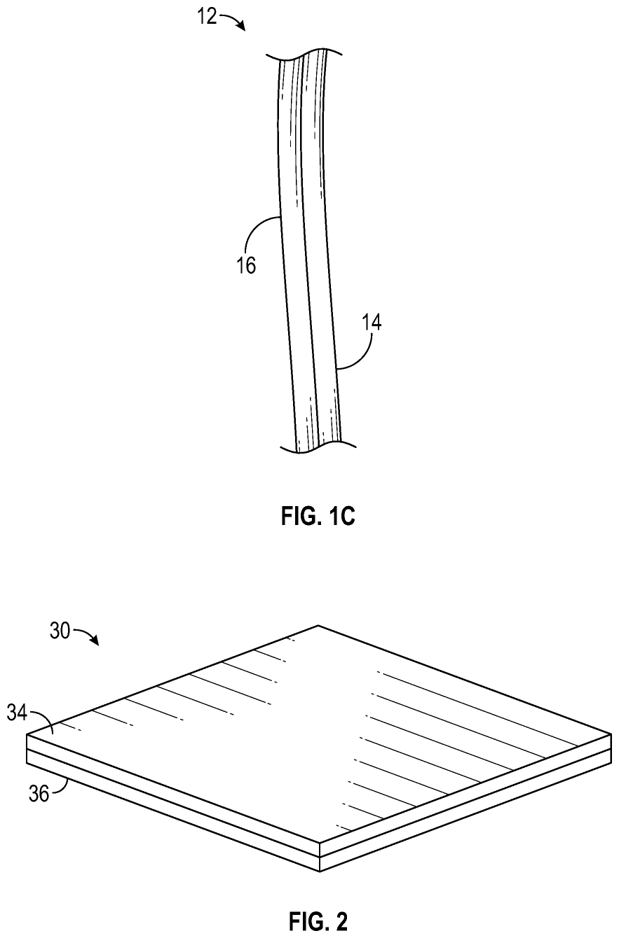

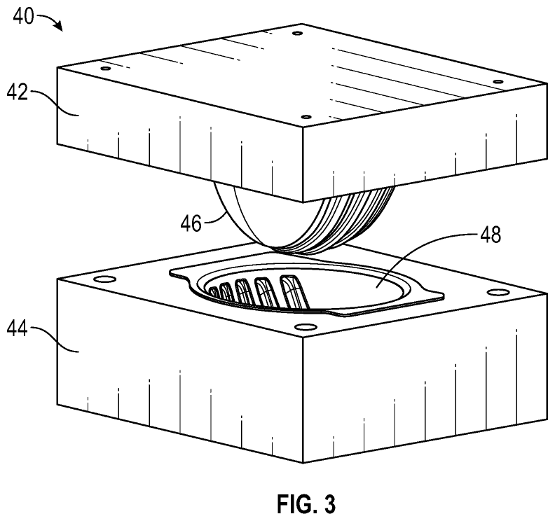

Filter body 11 and face mask 10 may be formed by thermoforming from a precursor composite, as described with reference to FIGS. 2 and 3.

FIG. 2 is a conceptual diagram showing a plan view of a precursor composite film 30 including a first layer 34 of a precursor polymeric material adjacent a second layer 36 of a precursor polymer film. The precursor polymeric material in first layer 34 includes substantially sintered or partially sintered polymeric beads, particles, or material, such that thermoforming may result in further sintering, stretching, and shaping of the precursor polymeric material to form the sintered and porous polymeric material in first layer 14.

Without being bound by theory, low melt flow polymers are preferable for use in porous first layer 34. For example, low or very low melt flow polymers may soften or tackify in response to thermal processing, but yet retain the general shape and continue to support adjacent second layer 36. The low or very low melt flow polymers may include polyethylene, for example, high density polyethylene (HDPE) or ultra-high molecular weight polyethylene (UHMWPE) or suitable fractional melt polypropylene materials.

Precursor polymer film of second layer 36 includes an unexpanded, partially expanded, or expanded polymer film, which is capable of further expansion or stretching, such that thermoforming results in further expansion or stretching to form expanded polymer film in second layer 16. Such a second layer 36 may be thermoformed in conjunction with first layer 34 while continuing to stretch or expand, and providing relative high airflow with good filtration. Without being bound by theory, it may be difficult to thermoform such a polymer film in second layer 36 without the support of porous sintered/sinterable first layer 34.

Precursor film 30 may be formed by coating, extruding, dispersing, laminating or otherwise depositing of one of first and second layers 34 and 36 on the other of first and second layers 34 and 36. For example, beads or particles of first layer 34 may be deposited on second layer 36. In embodiments, first layer 34 is laminated to second layer 36 in precursor film 30.

Precursor film 30 may be molded in a mold assembly to form a face mask, for example, as described with reference to FIG. 3.

FIG. 3 is a conceptual diagram showing a perspective view of a two-part mold assembly 40 for making a face mask. Mold assembly 40 includes a first mold portion 42 and a second mold portion 44. Mold assembly 40 may be formed of any suitable material, for example, metal, alloy, ceramic, polymer, glass, or any material that can sustain temperatures associated with thermoforming of precursor film 30 into face masks.

Sheet of precursor film 30 may be placed between first mold portion 42 and second mold portion 44, for example, between lower surface 46 of first mold portion 42 and upper surface 48 of second mold portion 44. Lower surface 46 and upper surface 48 define a predetermined shape, for example, configured to impart a predetermined curvature and texture to precursor film 30. In embodiments, first mold portion 42 and second mold portion remove heat from precursor film 30 during processing. Such removal of heat may promote the cooling of thermally processed material to assume and retain the three-dimensional shape imparted by mold assembly 40. After molding, the precursor film 30 transforms to a composite film, such as composite film 12 of FIGS. 1A and 1B, which includes a stretched sintered polymeric layer and an expanded polymer film, for example, an expanded PTFE film.

Precursor material is thermoformed between first mold portion 42 and second mold portion 44, in response to a predetermined temperature. For example, mold assembly 40 may be heated to a temperature in a range of 250° F. to 450° F. (120° C. to 230° C.). In some embodiments, one or both of precursor film 30 or mold assembly 40 may be heated. Mold assembly 40 may be operated at atmospheric pressure, partial vacuum, or vacuum, or under pressure, as known in the art.

Thus, mold assembly 40 subjects precursor film 30 to stretching and forming to form a molded shape, for example, of a face mask such as face mask 11.

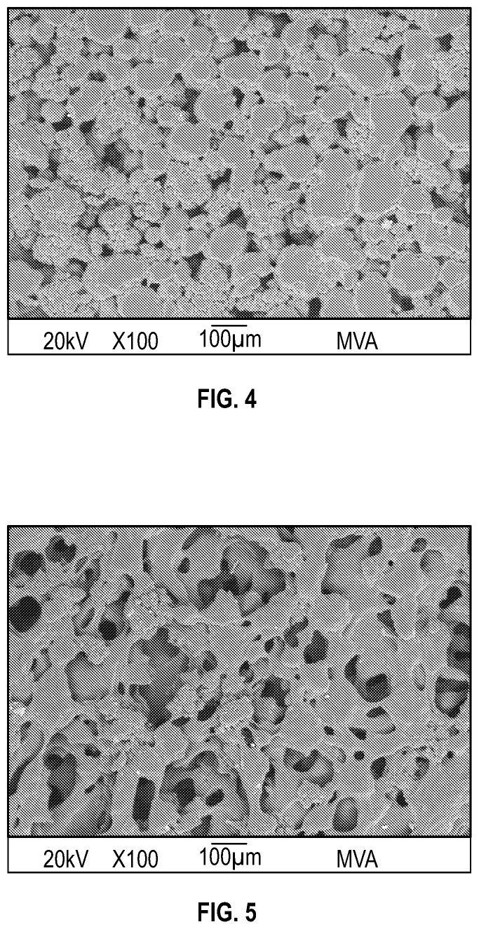

The change in the structure of precursor polymer material in first layer 34 to sintered polymer material in first layer 14 by thermoforming is shown in FIGS. 4 and 5.

FIG. 4 is a photograph showing a scanning electron microscopy (SEM) image of a precursor sintered polymeric material before thermoforming. FIG. 5 is a photograph showing a scanning electron microscopy (SEM) image of a sintered polymeric material of FIG. 4 after thermoforming.

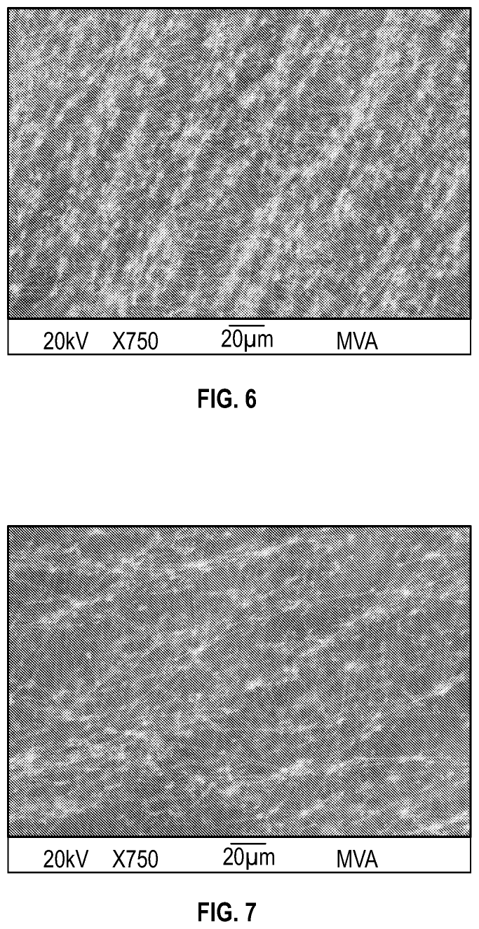

The change in the structure of polymer film in second layer 36 to expanded polymer film in second layer 16 by thermoforming is shown in FIGS. 6 and 7.

FIG. 6 is a photograph showing a scanning electron microscopy (SEM) image of a precursor expanded polymeric film (PTFE) before thermoforming. FIG. 7 is a photograph showing a scanning electron microscopy (SEM) image of the polymeric film of FIG. 6 after thermoforming.

The unformed expanded PTFE shown in FIG. 6 has filtration properties that make it suitable for use a medical mask (captures small particles at a rate greater than 95% efficiency), but may be too difficult to breathe through. Similarly, the unstretched porous precursor polymeric material shown in FIG. 4 is formable and breathable, but by itself, may lack the filtration efficiency required by medical masks. Used together as a laminate, and without forming or further thermal treatment, the precursor film 30 offers appropriate filtration efficiency, but may be too restrictive and lacks sufficient breathability, while also lacking a three-dimensional conforming shape.

By forming composite film 12 from precursor film 30, the resulting composite film 12 undergoes stretch, the permeability of the material as a whole is increased, and breathability of the material as a whole is improved. The forming also shapes the precursor film 30 with shape, a feature suitable for the eventual production of face mask 10.

Because the precursor film 30 is formable and can be shaped with a mold assembly such as mold assembly 40, a variety of geometries can be molded. While this feature enables the formation of multiple sizes, this feature also enables for different amounts of compression and/or stretch of the precursor film 30. Compression of precursor film 30 may result in a non-porous material with added strength. This feature can be used around the perimeter of the mask, for example, to reinforce anchor points for straps 18, and can also be used to reinforce the thin walled mask material with structural ribs 22. Such features may both reduce mask flex (during inhalation and exhalation) and also provide for a convenient means to reposition face mask 10. Additional stretch in certain regions of the mask may result in a variable wall thickness which can be utilized to create regions in the mask to enhance breathability.

Surprisingly, the filtration efficiency of the formed composite film 12 is very well preserved to levels that are similar to that of the precursor film 30. Similarly, the splash resistance of the formed composite film 12 exceeds that required by most mask standards, for example, being at least as high as 160 mm Hg.

Unlike conventional masks, masks according to the present disclosure may not include electret materials. By using polymeric base materials, the mask can be submerged into isopropyl alcohol and sterilized. Performance testing has shown that the filtration efficiencies of the resulting sterilized mask still offer filtration efficiencies above 95%, and thus meet NISOH N95 ratings after sterilization.

While processes for forming face masks are described with reference to mold assembly 40, any suitable system, apparatus, or assembly may be used to form face masks according to the disclosure. Further, while face masks have been described, precursor film 30 may be used to form any suitable air-filtration media, for example, for residential, commercial, or transportation applications. For example, precursor film 30 may be thermally processed or thermoformed in other molds, to provide objects having different shapes or sheet-formed objects apart from face masks.

### EXEMPLARY EMBODIMENTS

### Embodiment 1

A face mask comprising: a filter body comprising a composite film, the composite film comprising: a first layer of a sintered polymeric material, and a second layer of an expanded polymer film secured to the first layer; and one or more straps for securing the filter body over the mouth and nose of a wearer.

### Embodiment 2

The face mask of Embodiment 1, wherein the second layer defines an interior surface configured to face the wearer.

### Embodiment 3

The face mask of Embodiment 1 or 2, wherein the expanded polymer film comprises an expanded fluoropolymer matrix.

### Embodiment 4

The face mask of Embodiment 3, wherein the fluoropolymer comprises polytetrafluoroethylene (PTFE).

### Embodiment 5

The face mask of any one of Embodiments 1 to 4, wherein the sintered polymeric material comprises polyethylene.

### Embodiment 6

The face mask of any one of Embodiments 1 to 5, wherein the sintered polymeric material is laminated to the expanded polymer film.

### Embodiment 7

The face mask of any one of Embodiments 1 to 6, wherein the filter body consists of the composite film.

### Embodiment 8

The face mask of any one of Embodiments 1 to 7, wherein the filter body has a convex-concave shape and is dimensioned to fit about the wearer's mouth and noses.

### Embodiment 9

The face mask of any one of Embodiments 1 to 8, wherein the filter body is shaped by a thermoforming process.

### Embodiment 10

The face mask of any one of Embodiments 1 to 9, wherein the filter body defines one or more support ribs.

### Embodiment 11

The face mask of any one of Embodiments 1 to 10, further comprising a nose piece attached to the filter body.

### Embodiment 12

The face mask of any one of Embodiments 1 to 11, further comprising an air-valve secured to the filter body.

### Embodiment 13

The face mask of any one of Embodiments 1 to 12, wherein the first layer has a thickness in a range of 0.005 inch to 0.125 inch (0.1 mm to 3.2 mm).

### Embodiment 14

The face mask of any one of Embodiments 1 to 13, wherein the second layer has a thickness in a range of 0.0005 inch to 0.005 inch (0.01 mm to 0.1 mm).

### Embodiment 15

The face mask of any one of Embodiments 1 to 14, wherein a ratio of a thickness of the first layer to a thickness of the second layer is in a range of 1 to 250.

### Embodiment 16

The face mask of any one of Embodiments 1 to 15, wherein the composite film has a thickness in a range of 0.0055 inch to 0.130 inch (0.14 mm to 3.3 mm).

### Embodiment 17

A process for making a face mask, the process comprising: providing a precursor composite film comprising a precursor polymeric material adjacent a precursor polymer film; thermoforming the precursor composite film to produce a filter body of the face mask; and optionally attaching one or more straps to the filter body.

### Embodiment 18

The process of Embodiment 17, further comprising, after the thermoforming, trimming the composite film.

### Embodiment 19

The process of Embodiment 17 or 18, further comprising, after the thermoforming, attaching a nose piece to the filter body.

### Embodiment 20

The process of any one of Embodiments 17 to 19, further comprising, after the thermoforming, attaching an air-valve to the filter body.

### Embodiment 21

A face mask comprising: a filter body comprising a composite film, the composite film comprising: a first layer of a sintered polymeric material, and a second layer of an expanded polymer film secured to the first layer, wherein the filter body is shaped and dimensioned to cover the mouth and nose of a person.

### Embodiment 22

The face mask of Embodiment 21, wherein the second layer defines an interior surface configured to face the wearer.

### Embodiment 23

The face mask of Embodiment 21 or 22, wherein the expanded polymer film comprises an expanded fluoropolymer matrix.

### Embodiment 24

The face mask of Embodiment 23, wherein the fluoropolymer comprises polytetrafluoroethylene (PTFE).

### Embodiment 25

The face mask of any one of Embodiments 21 to 24, wherein the sintered polymeric material comprises polyethylene.

### Embodiment 26

The face mask of any one of Embodiments 21 to 25, wherein the sintered polymeric material is laminated to the expanded polymer film.

### Embodiment 27

The face mask of any one of Embodiments 21 to 26, wherein the filter body consists of the composite film.

### Embodiment 28

The face mask of any one of Embodiments 21 to 27, further comprising one or more straps configured to secure the filter body over the mouth and nose of a wearer.

The detailed description set forth above is provided to aid those skilled in the art in practicing the invention. However, the invention described and claimed herein is not to be limited in scope by the specific embodiments described above, as these embodiments are presented as mere illustrations of several aspects of the invention. Any combinations and modifications of the described methods and components, and compositions used in the practice of the methods, in addition to those not specifically described, will become apparent to those skilled in the art based on the present disclosure and do not depart from the spirit or scope of the present invention. Such variations, modifications, and combinations are also encompassed by the present disclosure and fall within the scope of the appended claims.

1. A face mask comprising:
a filter body comprising a composite film, the composite film comprising:
a first layer of a sintered polymeric material, and
a second layer of an expanded polymer film secured to the first layer; and
optionally one or more straps for securing the filter body over the mouth and nose of a wearer.

2. The face mask of claim 1, wherein the second layer defines an interior surface configured to face the wearer.

3. The face mask of claim 1, wherein the expanded polymer film comprises an expanded fluoropolymer matrix.

4. The face mask of claim 3, wherein the fluoropolymer comprises polytetrafluoroethylene (PTFE).

5. The face mask of claim 1, wherein the sintered polymeric material comprises polyethylene.

6. The face mask of claim 1, wherein the sintered polymeric material is laminated to the expanded polymer film.

7. The face mask of claim 1, wherein the filter body consists of the composite film.

8. The face mask of claim 1, wherein the filter body defines one or more support ribs.

9. The face mask of claim 1, further comprising a nose piece attached to the filter body.

10. The face mask of claim 1, further comprising an air-valve secured to the filter body.

11. The face mask of claim 1, wherein the first layer has a thickness in a range of 0.005 inch to 0.125 inch (0.1 mm to 3.2 mm).

12. The face mask of claim 1, wherein the second layer has a thickness in a range of 0.0005 inch to 0.005 inch (0.01 mm to 0.1 mm).

13. The face mask of claim 1, wherein a ratio of a thickness of the first layer to a thickness of the second layer is in a range of 1 to 250.

14. The face mask of claim 1, wherein the composite film has a thickness in a range of 0.0055 inch to 0.130 inch (0.14 mm to 3.3 mm).

15. The face mask of any one of claims 1 to 14, wherein the filter body has a convex-concave shape and is dimensioned to fit about the wearer's mouth and noses.

16. The face mask of claim 15, wherein the filter body is shaped by a thermoforming process.

17. A process for making a face mask, the process comprising:
providing a precursor composite film comprising a precursor polymeric material adjacent a precursor polymer film;
thermoforming the precursor composite film to produce a filter body of the face mask; and
optionally attaching one or more straps to the filter body.

18. The process of claim 17, further comprising, after the thermoforming: trimming the composite film, attaching a nose piece to the filter body, and/or attaching an air-valve to the filter body.

19-20. (canceled)

21. A face mask comprising:
a filter body comprising a composite film, the composite film comprising:
a first layer of a sintered polymeric material, and
a second layer of an expanded polymer film secured to the first layer,
wherein the filter body is shaped and dimensioned to cover the mouth and nose of a person.

22-33. (canceled)

34. The face mask of claim 21, further comprising one or more straps configured to secure the filter body over the mouth and nose of a wearer.
